(19) United States
(12) Patent Application Publication
(10) Pub. No.: US 2026/0336955 A1
(43) Pub. Date: Oct. 29, 2026

(54) BIN SWEEP SYSTEM FOR MOVING PARTICULATE MATERIAL IN A BIN

(71) Applicant: Sioux Steel Compnay, Sioux Falls, SD (US)

(72) Inventors: Jesse Horstman, Sioux Falls, SD (US); James Steever, Lennox, SD (US)

(73) Assignee: Siouox Steel Company, Sioux Falls, SD (US)

(21) Appl. No.: 19/190,054

(22) Filed: Apr. 25, 2025

(51) Int. Cl. B65G 65/42; B65D 88/74

(52) U.S. Cl. CPC B65G 65/425; B65D 88/74; B65G 2201/042

(57) ABSTRACT

A bin sweep system for moving particulate material in a bin includes a sweep arm, a sweep drive assembly, a particulate sweep assembly, and a housing extension. The sweep arm is elongated and has an inboard end and an outboard end. The sweep arm includes a housing extending along the sweep arm. The sweep drive assembly is coupled to the sweep arm to move the sweep arm about the central post of the bin. The particulate sweep assembly is mounted on the sweep arm under the housing to move particulate material toward the inboard end of the sweep arm. The housing extension is coupled to the outboard end of the sweep arm. The housing extension includes a front section and a rear section, each including a plurality of apertures for passage of particulate material through the housing extension to facilitate movement of the sweep arm through the particulate material. The housing extension is suspended in a cantilevered manner on the sweep arm such that the housing extension floats freely above the bin floor with space between the housing extension and the bin floor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bin sweeps and more particularly pertains to a new bin sweep system for facilitating movement of a sweep arm through the particulate material. A housing extension on the outboard end of the sweep arm has apertures that allow particulate material to pass through and under the extension to circulate the grain to alleviate and avoid the conditions that lead to stoppages of the bin sweep system. (2) Description of Related Art Including Information Disclosed Under 37 CFR 1.97 and 1.98

The prior art relates to bin sweeps. The prior art, as best understood, does not disclose a bin sweep system for moving particulate material in a bin having a bin floor that includes a sweep arm, a sweep drive assembly, a particulate sweep assembly, and a housing extension, wherein the housing extension includes a front section and a rear section, each of which includes a plurality of apertures designed for passage of the particulate material through the housing extension to facilitate movement of the sweep arm through the particulate material. The housing extension is suspended in a cantilevered manner on the sweep arm such that the housing extension floats freely above the bin floor with space between the housing extension and the bin floor.

### BRIEF SUMMARY OF THE INVENTION

An embodiment of the disclosure meets the needs presented above in a bin sweep system for moving particulate material in a bin having a bin floor generally comprising a sweep arm, a sweep drive assembly, a particulate sweep assembly, and a housing extension. The sweep arm is elongated and has an inboard end and an outboard end. The inboard end is positionable at a central post of a bin. The sweep arm includes a housing extending along the sweep arm. The sweep drive assembly is coupled to the sweep arm. The sweep drive assembly is designed to move the sweep arm in a circular sweep path along a bin floor about the central post of the bin. The particulate sweep assembly is mounted on the sweep arm under the housing. The particulate sweep assembly is designed to move particulate material on the bin floor along the sweep arm toward the inboard end of the sweep arm. The housing extension is coupled to the outboard end of the sweep arm. The housing extension is positionable between the outboard end and a perimeter wall of the bin. The housing extension includes a front section and a rear section. Each of the front section and the rear section includes a plurality of apertures designed for passage of the particulate material through the housing extension to facilitate movement of the sweep arm through the particulate material. The housing extension is suspended in a cantilevered manner on the sweep arm such that the housing extension floats freely above the bin floor with space between the housing extension and the bin floor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a bin sweep system according to an embodiment of the disclosure in use in a bin for containing particulate material, such as grain.

FIG. 2 is a perspective view of an embodiment of the disclosure.

FIG. 3 is a top perspective view of a section of an embodiment of the disclosure.

FIG. 4 is a top perspective view of a section of an embodiment of the disclosure.

FIG. 5 is a bottom perspective view of a section of an embodiment of the disclosure.

FIG. 6 is a front perspective view of a section of an embodiment of the disclosure.

FIG. 7 is a front view of a section of an embodiment of the disclosure in use.

FIG. 8 is a rear view of a section of an embodiment of the disclosure in use.

### DETAILED DESCRIPTION OF THE INVENTION

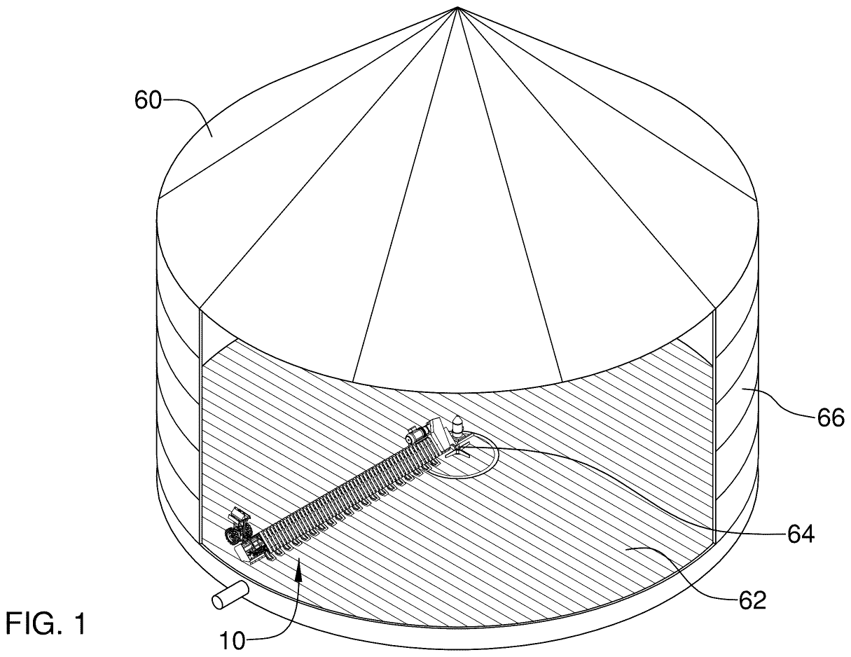

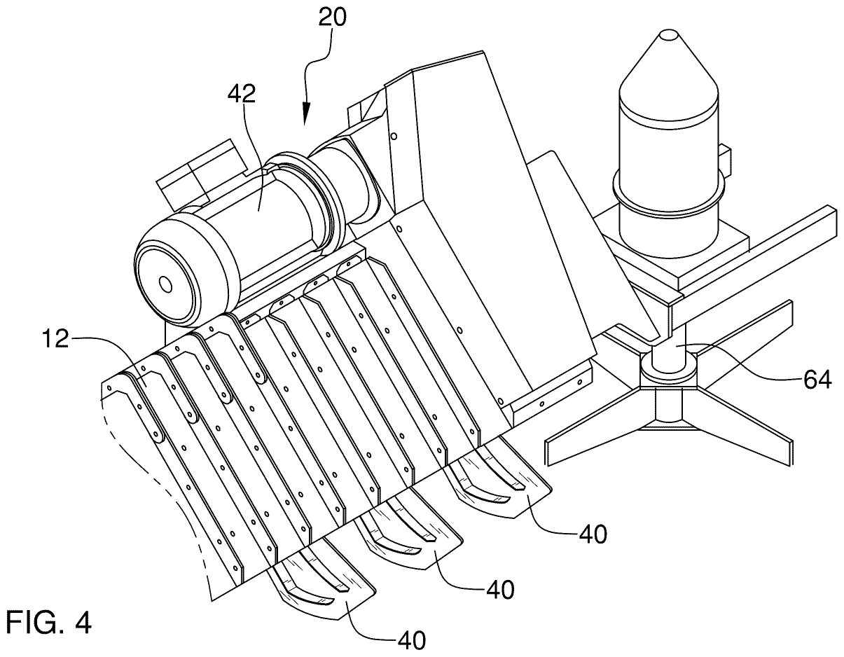

With reference now to the drawings, and in particular to FIGS. 1 through 8 thereof, a new bin sweep system embodying the principles and concepts of an embodiment of the disclosure and generally designated by the reference numeral 10 will be described.

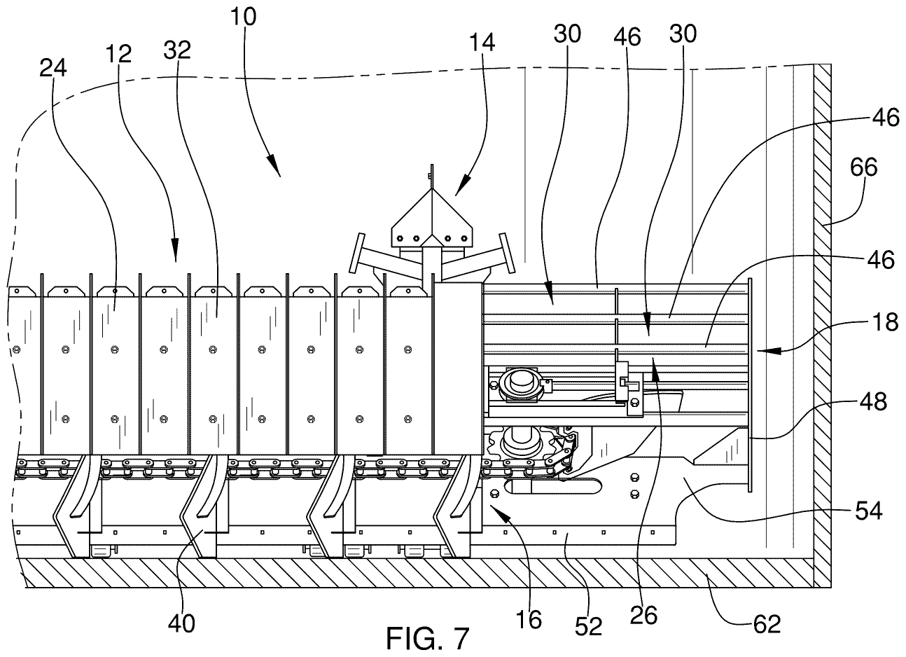

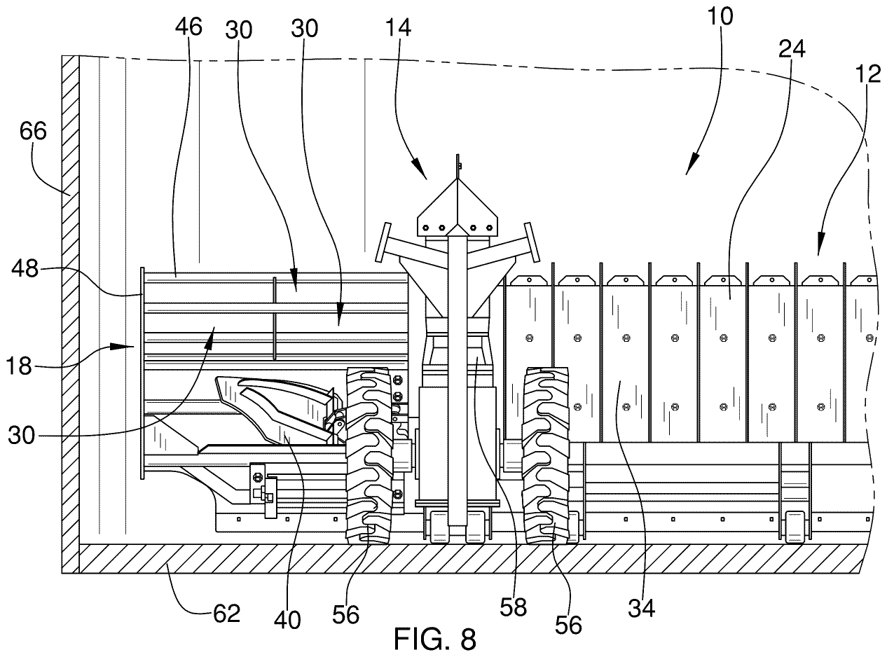

As best illustrated in FIGS. 1 through 8, the bin sweep system 10 for moving particulate material in a bin 60 having a bin floor 62 generally comprises a sweep arm 12, a sweep drive assembly 14, a particulate sweep assembly 16, and a housing extension 18. The sweep arm 12 is elongated and has an inboard end 20 and an outboard end 22. The inboard end 20 is positionable at a central post 64 of the bin 60. The sweep arm 12 includes a housing 24 extending along the sweep arm 12. The sweep drive assembly 14 is coupled to the sweep arm 12. The sweep drive assembly 14 is designed to move the sweep arm 12 in a circular sweep path along the bin floor 62 about the central post 64 of the bin 60. The particulate sweep assembly 16 is mounted on the sweep arm 12 under the housing 24. The particulate sweep assembly 16 is designed to move particulate material on the bin floor 62 along the sweep arm 12 toward the inboard end 20 of the sweep arm 12. The housing extension 18 is coupled to the outboard end 22 of the sweep arm 12. The housing extension 18 is positionable between the outboard end 22 and a perimeter wall 66 of the bin 60. The housing extension 18 includes a front section 26 and a rear section 28. Each of the front section 26 and the rear section 28 includes a plurality of apertures 30 designed for passage of the particulate material through the housing extension 18 to facilitate movement of the sweep arm 12 through the particulate material. As can be clearly seen in the exemplary embodiment in FIGS. 7 and 8, the housing extension 18 is suspended in a cantilevered manner on the sweep arm 12 such that the housing extension 18 floats freely above the bin floor 62 with space between the housing extension 18 and the bin floor 62.

To further explain, the bin sweep system 10 is used to sweep particulate material, such as, for example, grain, that is stored inside the bin 60. Sumps (not shown) are located in the bin floor 62, such as at the center where the central post 64 is positioned, which sumps allow the grain to fall by gravity out through the bin floor 62 and into an augur system (not shown), which in turn conducts the grain out of the bin 60, as is well known in the agricultural arts. While some of the grain can fall naturally into the sumps, the rest must be swept toward the sumps by the bin sweep system 10. In some instances, such as after an initial filling of the bin 60, the grain level can be relatively high, such that the bin sweep system 10 is immersed in the grain. The sweep drive assembly 14 is designed to push the sweep arm 12 through the grain, but sometimes the weight and density of the grain can cause the sweep drive assembly 14 to be overcome by the resistance force and thus result in the bin sweep system 10 becoming stuck. The housing extension 18 is designed to allow grain to pass through and under the housing extension 18, thereby reducing the resistance and helping to circulate the grain to alleviate and avoid the conditions that lead to stoppages. As is well known in the agricultural arts, the sweep arm 12 includes a plurality of support wheels 50 designed to support the sweep arm 12 on the bin floor 62. The support wheels 50 are positioned to contact the bin floor 62. In the exemplary embodiment, the housing extension 18, however, is suspended in a cantilevered manner on the sweep arm 12. In other words, in the exemplary embodiment, the housing extension 18 does not have any of the support wheels 50, but rather is supported in a free or floating manner solely by its connection to the sweep arm 12. This floating design of the housing extension 18 without support wheels 50 further promotes the movement of the housing extension 18 through the particular material by allowing the particulate material to pass under the housing extension 18 in addition to the movement of the particulate matter through the housing extension 18.

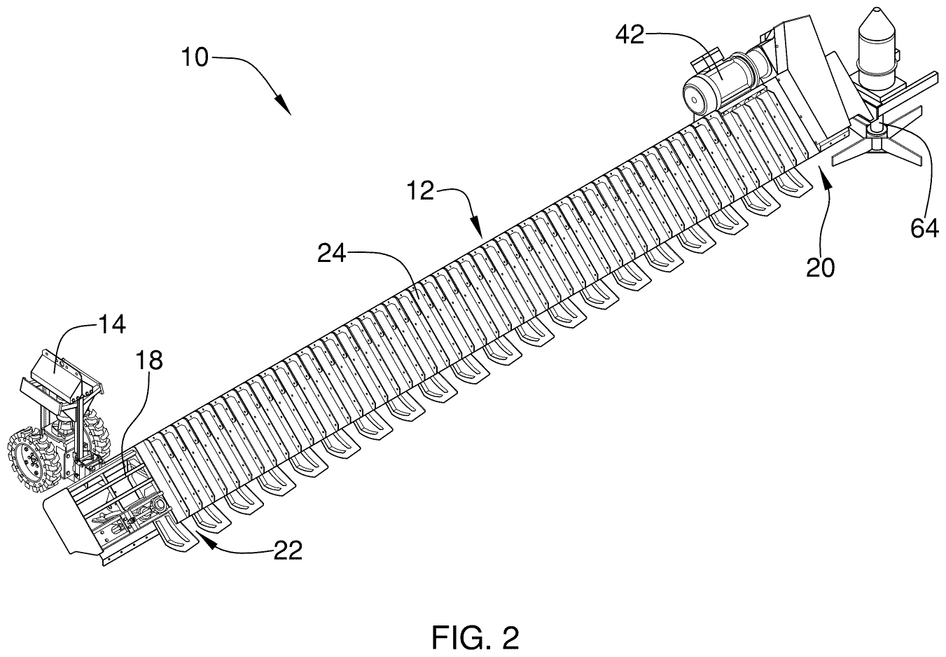

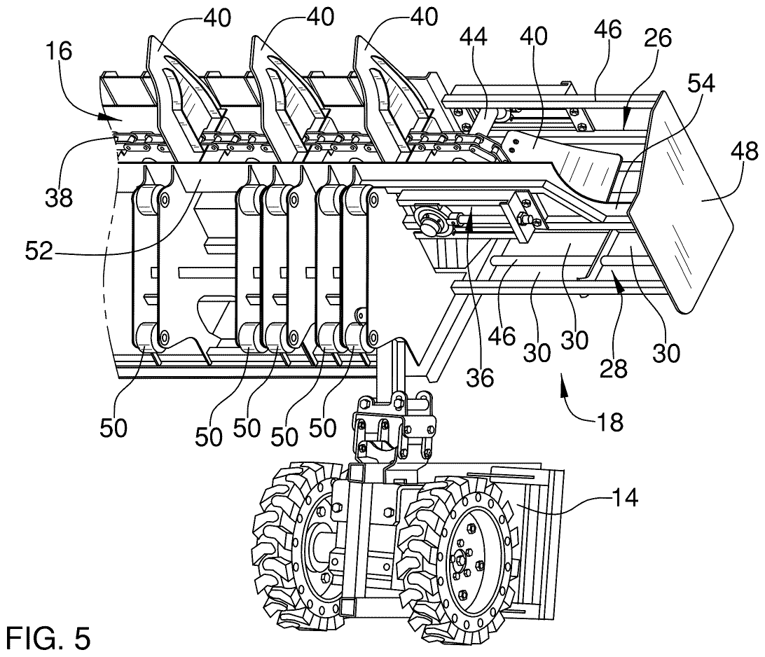

In the exemplary embodiment shown in FIGS. 2 and 5, the housing 24 has a front wall 32 and a rear wall 34. The front section 26 of the housing extension 18 extends from the front wall 32 of the housing 24, and the rear section 28 of the housing extension 18 extends from the rear wall 34 of the housing 24. In other words, the front section 26 functions like an extension of the front wall 32, and the rear section 28 functions like an extension of the rear wall 34. However, the apertures 30 allow the particulate material to pass through the housing extension 18 as opposed to the front wall 32 and the rear wall 34, which are solid and prevent passage of particulate material through the housing 24.

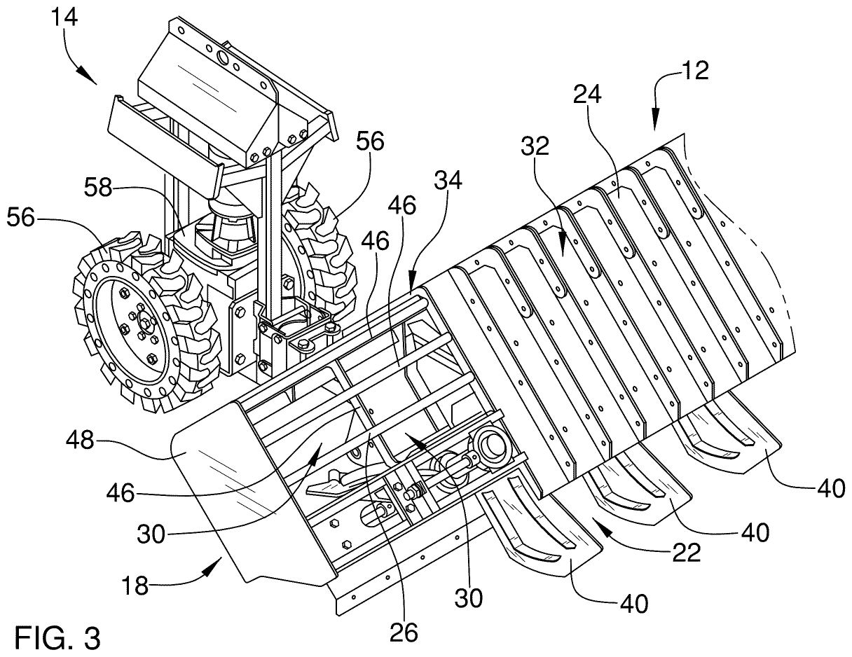

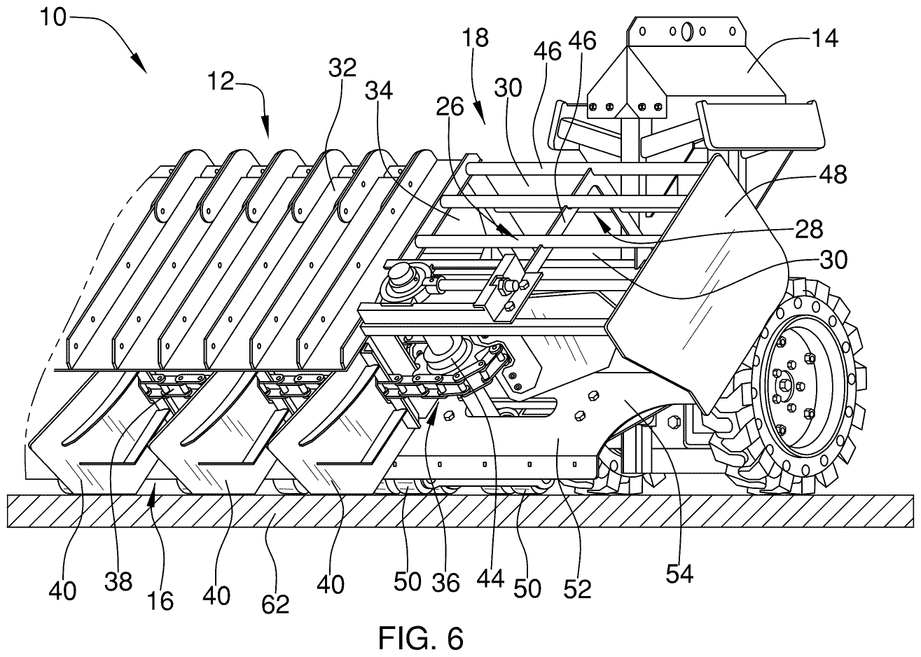

In the exemplary embodiment in FIGS. 3 and 6, the housing extension 18 is positioned over an end portion 36 of the particulate sweep assembly 16. In the exemplary embodiment, the particulate sweep assembly 16 includes an endless loop 38 and a plurality of paddles 40 supported on the endless loop 38. The particulate sweep assembly 16 includes a drive unit 42 coupled to the endless loop 38 to drive the endless loop 38 and move the paddles 40 along a circulating path and sweep particulate material toward the inboard end 20 of the sweep arm 12. For example, the endless loop 38 is a chain and the paddles 40 are spaced apart in intervals on the chain. As the chain is circulated, the paddles 40, which are oriented vertically with respect to the bin floor 62, contact and sweep particulate material inwardly toward the inboard end 20 of the sweep arm 12. As mentioned above, sumps (not shown) are located in the bin floor 62, such as at the center where the central post 64 is positioned, and the paddles 40 sweep the particulate matter into the sumps.

In the exemplary embodiment, the end portion 36 of the particulate sweep assembly 16 includes a loop support 44 mounted on the housing extension 18 and designed to support the endless loop 38. The loop support 44 can be in the form of an idler or tensioner sprocket or wheel to engage the chain. As can be seen in FIG. 6, the endless loop 38 makes a turn at the end portion 36 to bring the paddles 40 down to the bottom of the sweep arm 12 to sweep the particulate material.

In the exemplary embodiment, the housing extension 18 includes a plurality of elongated members 46 arranged in a framework. The elongated members 46 include horizontal bars and angular support pieces on which the horizontal bars are mounted. However, this is only one exemplary embodiment, and other designs are within the scope of the disclosure, such as solid panels with openings formed therein, or a combination of solid panels and elongated members 46, or possibly tubes or passages with side walls and open ends.

In the exemplary embodiment in FIG. 6, the housing extension 18 includes an end panel 48 coupled to the front section 26 and the rear section 28. The end panel 48 is positioned perpendicular to a longitudinal axis of the sweep arm 12. The end panel 48 is solid but could also include openings for the passage of particulate material.

The bin sweep system 10 further includes a wiper structure 52 that is mounted on the sweep arm 12 under the housing 24. The wiper structure 52 is designed to resist particulate material from passing underneath the sweep arm 12 during movement of the sweep arm 12. The wiper structure 52 is positioned rearward of the particulate sweep assembly 16. As can be seen in FIG. 6, the wiper structure 52 is behind the paddles 40, which pass in front of the wiper structure 52. The wiper structure 52 is positioned to extend along the housing 24 and into the housing extension 18, also as shown in FIG. 6. In this exemplary embodiment, the wiper structure 52 includes a recessed end portion 54 in the housing extension 18 designed for passage of the particulate material under the wiper structure 52. However, in another possible embodiment, the wiper structure 52 could terminate at the outboard end 22 of the sweep arm 12 to increase the passage of particulate material through the housing extension 18, or could extend to the end panel 48 of the housing extension 18 with the recessed end portion 54 omitted to restrict the passage of particulate material through the housing extension 18.

In the exemplary embodiment in FIGS. 3 and 5, the sweep drive assembly 14 is coupled to the outboard end 22 of the sweep arm 12 adjacent the housing extension 18. The positioning of the sweep drive assembly 14 near the housing extension 18 results in alleviation of resistance forces at the sweep drive assembly 14 to better avoid stoppages. The sweep drive assembly 14 includes a pair of drive wheels 56 and a drive device 58, as is well known in the agricultural arts, and other well known designs are within the scope of the disclosure. In addition, in the exemplary embodiment, the sweep arm 12 is modular and includes a plurality of interchangeable sections, which are shown as being connected into a single structure in the figures. Accordingly, the length of the sweep arm 12 can be adjusted as desired to fit bins of different diameters.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bin sweep system for moving particulate material in a bin having a bin floor comprising:
a sweep arm being elongated and having an inboard end and an outboard end, the inboard end being positionable at a central post of a bin, the sweep arm including a housing extending along the sweep arm;
a sweep drive assembly being coupled to the sweep arm, the sweep drive assembly being configured to move the sweep arm in a circular sweep path along a bin floor about the central post of the bin;
a particulate sweep assembly being mounted on the sweep arm under the housing, the particulate sweep assembly being configured to move particulate material on the bin floor along the sweep arm toward the inboard end of the sweep arm; and
a housing extension being coupled to the outboard end of the sweep arm, the housing extension being positionable between the outboard end and a perimeter wall of the bin, the housing extension including a front section and a rear section, each of the front section and the rear section including a plurality of apertures being configured for passage of the particulate material through the housing extension to facilitate movement of the sweep arm through the particulate material, the housing extension being suspended in a cantilevered manner on the sweep arm such that the housing extension floats freely above the bin floor with space between the housing extension and the bin floor.

2. The bin sweep system of claim 1, wherein:
the housing has a front wall and a rear wall;
the front section of the housing extension extends from the front wall of the housing; and
the rear section of the housing extension extends from the rear wall of the housing.

3. The bin sweep system of claim 1, wherein the housing extension is positioned over an end portion of the particulate sweep assembly.

4. The bin sweep system of claim 3, wherein:
the particulate sweep assembly includes an endless loop and a plurality of paddles supported on the endless loop; and
the particulate sweep assembly includes a drive unit coupled to the endless loop to drive the endless loop and move the paddles along a circulating path and sweep particulate material toward the inboard end of the sweep arm.

5. The bin sweep system of claim 4, wherein the end portion of the particulate sweep assembly includes a loop support mounted on the housing extension and configured to support the endless loop.

6. The bin sweep system of claim 1, wherein the housing extension includes a plurality of elongated members arranged in a framework.

7. The bin sweep system of claim 1, wherein:
the housing extension includes an end panel coupled to the front section and the rear section; and
the end panel is positioned perpendicular to a longitudinal axis of the sweep arm.

8. The bin sweep system of claim 1, wherein the sweep arm includes a plurality of support wheels configured to support the sweep arm on the bin floor.

9. The bin sweep system of claim 1, further including a wiper structure being mounted on the sweep arm under the housing, the wiper structure being configured to resist particulate material from passing underneath the sweep arm during movement of the sweep arm, the wiper structure being positioned rearward of the particulate sweep assembly, the wiper structure being positioned to extend along the housing and into the housing extension.

10. The bin sweep system of claim 9, wherein the wiper structure includes a recessed end portion in the housing extension configured for passage of the particulate material under the wiper structure.

11. The bin sweep system of claim 1, wherein the sweep drive assembly is coupled to the outboard end of the sweep arm adjacent the housing extension.

12. The bin sweep system of claim 1, wherein the sweep arm is modular and includes a plurality of interchangeable sections.

13. The bin sweep system of claim 5, wherein:
the housing has a front wall and a rear wall;
the front section of the housing extension extends from the front wall of the housing; and
the rear section of the housing extension extends from the rear wall of the housing.

14. The bin sweep system of claim 13, wherein the housing extension includes a plurality of elongated members arranged in a framework.

15. The bin sweep system of claim 14, wherein:
the housing extension includes an end panel coupled to the front section and the rear section; and
the end panel is positioned perpendicular to a longitudinal axis of the sweep arm.

16. The bin sweep system of claim 15, wherein the sweep arm includes a plurality of support wheels configured to support the sweep arm on the bin floor.

17. The bin sweep system of claim 16, further including a wiper structure being mounted on the sweep arm under the housing, the wiper structure being configured to resist particulate material from passing underneath the sweep arm during movement of the sweep arm, the wiper structure being positioned rearward of the particulate sweep assembly, the wiper structure being positioned to extend along the housing and into the housing extension.

18. The bin sweep system of claim 17, wherein the wiper structure includes a recessed end portion in the housing extension configured for passage of the particulate material under the wiper structure.

19. The bin sweep system of claim 18, wherein the sweep drive assembly is coupled to the outboard end of the sweep arm adjacent the housing extension.

20. The bin sweep system of claim 19, wherein the sweep arm is modular and includes a plurality of interchangeable sections.
